(19) United States
(12) Patent Application Publication
(10) Pub. No.: US 2002/0044860 A1
(43) Pub. Date: Apr. 18, 2002

(54) Processing system

(76) Inventors: Yoshinobu Hayashi, Amagasaki-Shi (JP); Mitsuyuki Yamaguchi, Tokyo (JP); Yasushi Kodashima, Tokyo (JP)

Correspondence Address: Pillsbury Winthrop LLP, Intellectual Property Group, Ninth Floor, 1100 New York Avenue, NW, Washington, DC, 20005-3918, US

(21) Appl. No.: 09/850,185

(22) Filed: May 8, 2001

Related U.S. Application Data
(63) Continuation of application No. PCT/JP01/02922, filed on Apr. 4, 2001.

(30) Foreign Application Priority Data
Apr. 5, 2000 (JP) 2000-103402

(51) Int. Cl. B65G 65/30

(52) U.S. Cl. 414/416.03; 414/416.08; 118/500; 414/937

(57) ABSTRACT

A processing system includes a transfer part (4) having a container disposed therein for performing taking out therefrom of a not-yet-processed object and loading therein the already-processed object; processing parts (11 through 18) for performing predetermined processing on the object; and a plurality of conveying units (21, 22) conveying the object between a first position for delivery of the object with the container disposed in the transfer part and a second position for delivery of the object with the processing part, wherein: each of the plurality of conveying units can move between the first position and second position; a moving path of the conveying units includes a plurality of paths each along an arrangement of the processing parts; and each of the conveying units can solely perform delivery of the object with the processing part on both sides or the transfer part.

### TECHNICAL FIELD

The present invention relates to a processing system for conveying an object such as a semiconductor substrate, for example, to a processing part, and performing processing on the object.

### BACKGROUND ART

Conventionally, as such a processing system, Japanese Laid-Open Patent Application No. 10-144765 discloses a substrate processing system in which, in a processing system for a semiconductor substrate, each processing part is divided into a plurality of parts, and, a conveying mechanism which moves in the thus-divided processing part and conveys the processing substrate is connected to a conveying path of a conveying unit which conveys the processing substrate between devices.

FIG. 1 shows the conveying path for the processing substrate in the substrate processing system, and the processing substrate from a substrate transfer part 4 from which the substrate which has not been processed yet is taken out is transferred from a conveying means a provided in the substrate transfer part 4 to the single conveying unit 2 which passes through the conveying path 3 between the respective processing parts, and, by this conveying unit 2, it is sent to the respective processing units.

The substrate to be processed there is transferred to the conveying means b which moves between the respective separate processing parts 11-13, 14-16, and 17-19, and, by this conveying means b, it is conveyed to a predetermined processing location, and undergoes predetermined processing. Then, the substrate which has been thus processed is, by the respective processing means b, transferred to the conveying unit 2 which moves between the processing parts, returns to the original transfer part 4, and, there, it is returned to a substrate container 5 by the conveying means a provided in the substrate transfer part 4. Thereby, the number of times of delivery and the number of times of conveying of the processing substrate within the system are reduced, and the time required for conveying is reduced, advantageously.

In this conventional system, with regard to a part of the substrate conveying path between the substrate transfer part and processing parts, for example, to a range in which the conveying unit 2 moves in FIG. 1, the conveyance of the substrate in this part is performed by the single conveying unit.

Therefore, the conveying capability (the number of substrates which can be conveyed within a unit time interval) when the plurality of substrates W are conveyed in sequence between the substrate transfer part 4 and processing parts 11-19, or between the processing part and processing part is limited depending on the conveying capability of the single conveying unit 2.

Accordingly, in a case where the number of processing parts is large, or a case where the processing time interval for the processing part is short, the net working rate of the processing part may be reduced. In order to improve the throughput (the number of substrates which can be processed by the processing parts within a unit time interval) of the entire system, it is necessary to shorten the processing time required in the processing part, and, also, to improve the net working rate of the processing part.

### DISCLOSURE OF THE INVENTION

A problem to be solved by the present invention is to provide a processing system in which a net working rate of a processing part is high, and it is possible to process a predetermined number of objects within a short time interval.

A processing system according to the present invention includes a transfer part in which a container such that an object which has not been processed yet is taken out therefrom and the object which has been already processed is loaded therein thereby is disposed, a processing part which performs predetermined processing on the object, and a plurality conveying units which convey the object between a first position at which the object is delivered with the container disposed in the transfer part and a second position at which the object is delivered with the processing part, and, each of the above-mentioned plurality of conveying units can move between the first position and second position.

By the processing system according to the present invention, even during conveyance of the object between the transfer part and the processing part performed by the one conveying unit, the other conveying unit can convey the other object. Thereby, it is possible that the plurality of objects are conveyed between the transfer part and processing parts in sequence within a short time interval, and, as a result, the net working rate of the processing part is improved, and, also, a predetermined number of objects can be processed within a short time interval.

In the processing system according to the present invention, the plurality of processing parts may be provided for performing a same type of processing, and, each of the plurality of conveying units may be able to move between the first position and the second position corresponding to each of the plurality of processing parts.

In this case, processing for the plurality of objects can be performed in parallel by the plurality of processing parts, and, also, distribution of the objects to the plurality of processing parts can be performed within a short time interval. Accordingly, it is possible that parallel processing for the plurality of objects can be performed within a short time interval.

Further, the plurality of processing parts may be provided for performing a plurality of processing in series, and, each of the plurality of conveying units may be able to move between the second positions corresponding to the respective ones of the plurality of processing parts. Thereby, without loading of the object into the container nor taking out the object from the container between processing and processing, a plurality of processing can be performed on the object successively, and, also, the plurality of objects can be conveyed from the processing part which performs antecedent processing to the processing part which performs subsequent processing in sequence within a short time interval. Accordingly, it is possible to perform successive processing for the plurality of objects within a short time interval.

Further, each of the plurality of conveying units may be able to move between the first position corresponding to the same container and the second position. Thereby, by conveying the plurality of objects held in the single container to the processing part in sequence within a short time interval by using the plurality of conveying units, it is possible to complete processing of the objects held in the single container within a short time interval.

Further, the number of conveying units and moving paths can be determined to be any ones, and, also, the number of processing parts to be disposed can be freely determined so as to deal with the number of conveying units, types of processing, and processing time.

Further, the transfer part which is used for taking out the object which has not been processed yet therefrom, and the transfer part which is used for loading the object which has been already processed therein may be unified into one location, or may be provided in separate positions according to the functions thereof.

Further, the moving path of the conveying unit may have a loop shape, and, the above-mentioned first and second positions may be located along this moving path.

In this case, while one conveying unit performs delivery of the object with the processing part or container, another conveying unit can convey the object to any processing part other than the processing to which the above-mentioned one conveying unit performs delivery of the object, without being disturbed by the one conveying unit. Accordingly, it is possible to improve the net working rate of the conveying unit, and, to improve the conveying capability of all the plurality of conveying units.

Further, the moving path of the conveying unit may have a main conveying path and a plurality of branches provided for the respective processing parts from the main conveying path to the second positions corresponding to the plurality of processing parts.

In this case, without being disturbed by one conveying unit which performs delivery of an object with the processing part, another conveying unit can convey an object to any processing part other than the processing part to which the above-mentioned one conveying unit performs delivery of the object. Accordingly, it is possible to improve the net working rate of the conveying unit, and, to improve the conveying capability of all the plurality of conveying units.

Further, as a result of the moving path of the conveying unit including a plurality of paths each (like approximately straight line) along the processing parts, the conveying unit is not needed to perform change of direction along the moving path, and, thereby, the moving path is not needed to have such a large radius of curvature as that allowing change of direction of the conveying unit. As a result, it is possible to effectively reduce an area of a region in which the moving path of the conveying unit is disposed.

Further, by providing a temporary placement stand in the middle between the moving paths, it is possible that delivery of the object between the conveying units is performed efficiently and smoothly.

Furthermore, by enabling one conveying unit to access the processing parts or transfer parts on both sides thereof, it is possible for the conveying operation to have variation, and to plan a conveying program flexibly. Further, even when one conveying unit has a trouble, another conveying unit can perform delivery of the object from all the processing parts and transfer parts. Accordingly, it is possible to prevent the currently performed processing from being interrupted.

Further, the moving path of the conveying unit may be one (like an approximately straight line) along the processing parts and having both ends thereof as being dead ends. Thereby, it is possible to further reduce an area of a region in which the moving path of the conveying unit is disposed. In this case, by providing escape regions at both ends of the moving path, and, as a result, causing some of a plurality of conveying units to escape thereto, the other conveying units can move all the required moving area. Further, by providing a temporary placement stand, it is possible that delivery between the conveying units can be performed efficiently and smoothly.

Other objects and further features of the present invention will be described in the following detailed description made in conjunction with the accompanying drawings.

### BRIEF DESCRIPTION OF THE DRAWINGS

FIG. 1 is a plan layout diagram showing a moving path of a conveying unit in a substrate processing system in the prior art;

FIG. 2 is a plan layout diagram showing a first example in embodiment of a processing system according to the present invention;

FIG. 3 is a perspective view showing a detail of a conveying unit;

FIG. 4 is a plan layout diagram showing a second example in embodiment of a processing system according to the present invention;

FIG. 5 is a plan layout diagram showing a third example in embodiment of a processing system according to the present invention;

FIG. 6 is a plan layout diagram showing a fourth example in embodiment of a processing system according to the present invention;

FIG. 7 illustrates an example of operation of a transfer unit of a conveying unit in the example in embodiment shown in FIG. 6 (#1);

FIG. 8 illustrates an example of operation of the transfer unit of a conveying unit in the example in embodiment shown in FIG. 6 (#2);

FIG. 9 illustrates an example of operation of the transfer unit of a conveying unit in the example in embodiment shown in FIG. 6 (#3);

FIG. 10 illustrates an example of operation of the transfer unit of a conveying unit in the example in embodiment shown in FIG. 6 (#4);

FIG. 11 illustrates an example of operation of the transfer unit of a conveying unit in the example in embodiment shown in FIG. 6 (#5);

FIG. 12 is a plan layout diagram showing a fifth example in embodiment of a processing system according to the present invention;

FIG. 13 is a plan view showing one example of a form of a processing part for performing vacuum processing;

FIG. 14 is a plan view showing another example of a form of a processing part for performing vacuum processing;

FIG. 15 is a plan view showing another example of a form of a processing part for performing vacuum processing;

FIG. 16 is a plan view showing one example of a form of a processing part for performing processing under atmospheric pressure;

FIG. 17 is a plan view showing another example of a form of a processing part for performing processing under atmospheric pressure; and

FIG. 18 is a plan layout diagram showing a sixth example in embodiment of the processing system.

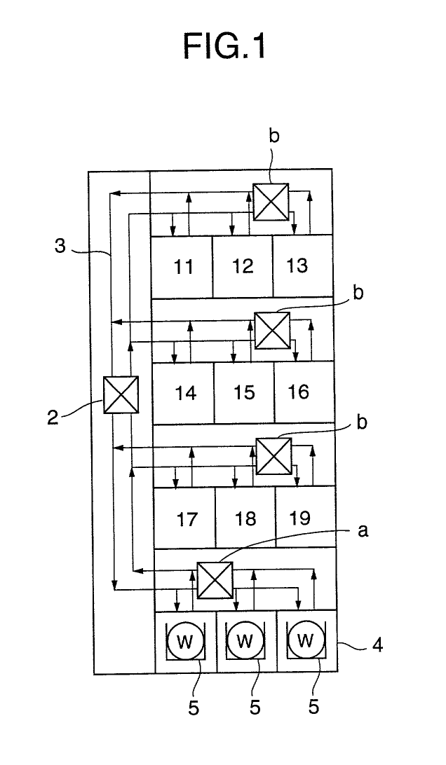

### BEST EMBODIMENT FOR CARRYING OUT THE INVENTION

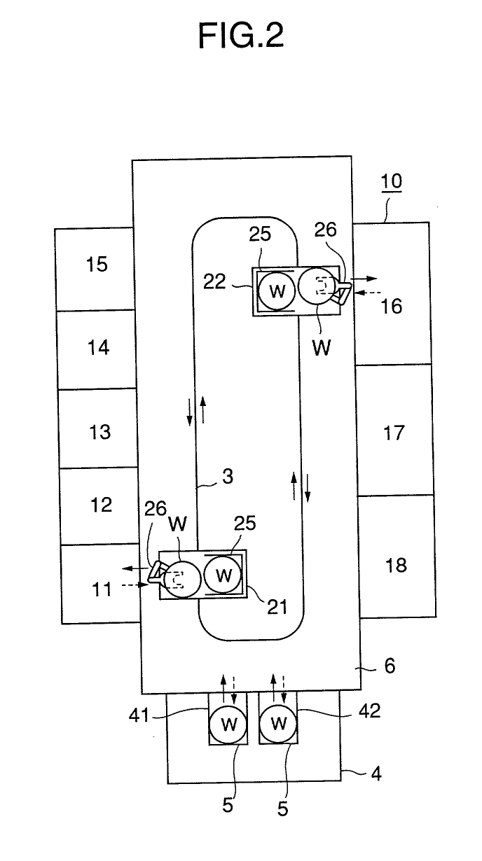

Examples in embodiment of the present invention will now be described. FIG. 2 shows a first example of a processing system according to the present invention. Processing parts in the processing system shown in the figure are disposed at five locations 11 through 15 on one side, and at three locations 16 through 18 on the other side. Two conveying units 21 and 22 are disposed and can move, respectively, independently, along a loop-like moving path 3 along an inner periphery of the processing parts 11 through 18. 4 denotes a substrate transfer part, and the conveying units 21 and 22 are disposed inside of a conveyance chamber 6. A fan filter unit, not shown in the fighter, is provided in a ceiling part of the conveyance chamber 6, so that clean air is provided into the conveyance chamber 6. Respective positions for delivery of a substrate W with two substrate containers 5 disposed in the substrate transfer part 4 and respective positions for delivery of the substrate W with the processing parts 11 through 18 are disposed along the moving path 3. The substrate containers 5 are disposed in the substrate transfer part 4 and have inner spaces which communicate with a space inside of the conveyance chamber 6, and delivery of the substrates between the substrate containers 5 and the conveying units 21 and 22 is performed. It is preferable that the substrate containers 5 are sealed while they are conveyed from the outside to the substrate transfer part 4, and, also they are conveyed from the transfer part 4 to the outside. Operations in that the substrate container 5 conveyed from the outside to the transfer part 4 in the sealed state is caused to communicate with the space inside of the conveyance chamber 6, and the substrate container 5 communicating with the inner space of the conveyance chamber 6 is returned to the sealed state, can be achieved by using the art disclosed by Japanese Laid-Open Patent Application No. 8-279546, for example.

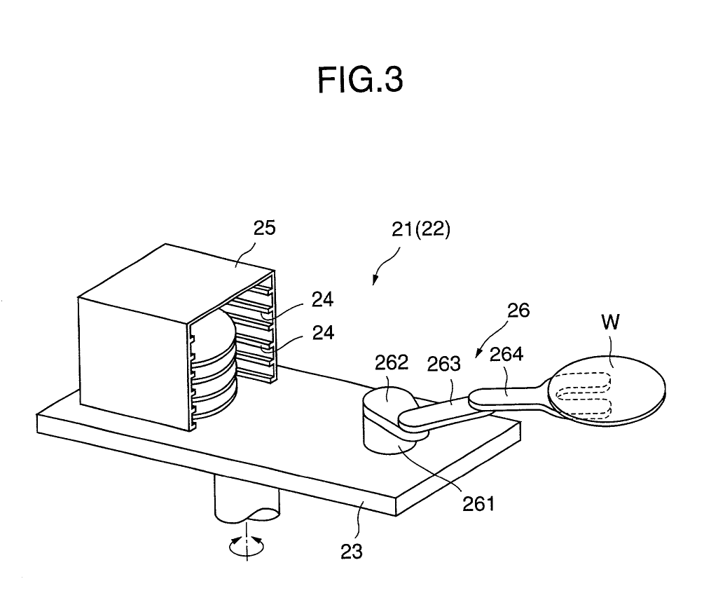

FIG. 3 is a perspective view showing a detail of the conveying unit 21, 22. The conveying unit 21, 22 includes a base stand 23 which can move horizontally along the moving path 3 and can rotate at any position, a buffer mechanism 25 provided at one side on the base stand 23 and having a plurality of supporting parts 24 which support edges of the substrates W formed therein in a multi-stage manner, and a robot arm 26 provided at the other side on the base stand 23. The robot arm 26 includes a lifting/lowering shaft 261 provided at the other side on the base stand 23, a first arm 262 which can move vertically by lifting/lowering of the lifting/lowering shaft 261 and can rotate about the lifting/lowering shaft 261, a second arm 263 rotatable with respect to the first arm 262, and a third arm 264 rotatable with respect to the second arm 263 on which the substrate W is placed. Move of the base stand 23 along the moving path 3 can be achieved by using a running mechanism which is used in a self-running RGV (Rail Guided Vehicle) which is guided by a rail set on a floor, for example.

This conveying unit 21, 22 can perform, through rotation of the first through third arms 262, 263 and 264, delivery of the substrate W with the container 5 (see FIG. 2) at a position at which delivery of the substrate W is performed with the container 5, and, also, delivery of the substrate W with the processing part 11 through 18 at position at which delivery of the substrate W is performed with the processing part 11 through 18.

Further, the conveying unit 21, 22 can perform storage of the plurality of substrates W in the buffer mechanism 25 by holding the substrates W, received, one by one, from the container 5 or the processing part 11 through 18, into the buffer mechanism 25 in sequence, and, also, transfer of the plurality of substrates W, held in the buffer mechanism 25, to the container 5 or the processing part 11 through 18, one by one.

Further, the conveying unit 21, 22 can perform, at a position at which the substrate W is delivered with the processing part 11 through 18, storage of the substrate W which has been already processed, received from the processing part 11 through 18, into the buffer mechanism 25, and transfer of the substrate W which has not been processed yet held in the buffer mechanism 25 to the processing part 11 through 18.

Returning to FIG. 2, the substrate W to be processed is transferred to either one of the conveying units 21 and 22 by the robot arm 26 mounted on the conveying unit, from the substrate container 5 disposed in the substrate transfer part 41 or the substrate transfer part 42, and, along the loop-like moving part 3, it is conveyed toward the predetermined processing part. At a position at which delivery of the substrates W is performed with the predetermined processing part (11 and 16 in the figure), the substrate W is loaded into each processing part. Then, in each processing part, predetermined processing is performed on the substrate W, which is then returned to any conveying unit which has moved to the position. Then, the substrate W is returned along the moving part 3 into the substrate container 5 disposed in the substrate transfer part 41 or substrate transfer part 42, or is conveyed to the other processing part. In this time, even when the processing time is different in each processing part, as the two conveying units are provided, and, also, as the loop-like moving path 3 is provided, the substrate W having undergone the processing earlier can be conveyed to the predetermined location earlier.

In the processing system 10 shown in FIG. 2, the two conveying units are provided, and, also, the loop-like moving path 3 is provided. Thereby, while one conveying unit performs delivery of the object with the processing part or the container, another conveying unit can convey and transfer a substrate W to any processing part or container other than the processing part or container for which the above-mentioned one conveying unit performs delivery of the substrate, without being disturbed by the one conveying unit. Thereby, it is possible to improve the net working rate of each conveying unit, and, also, to improve the transfer capability (the number of substrates which can be conveyed within a unit time interval) of all the two conveying units.

In the example shown in FIG. 2, the substrate transfer parts 41 and 42 are substrate transfer parts for performing both taking out of substrates W which have not been processed yet and loading substrates W which have been already processed. However, in the processing system 10 shown in FIG. 2, it is also possible that the substrate transfer part 41 is a substrate transfer part for taking out of substrates W which have not been processed yet therefrom and the substrate transfer part 42 is a substrate transfer part for loading substrates W which have been already processed therein.

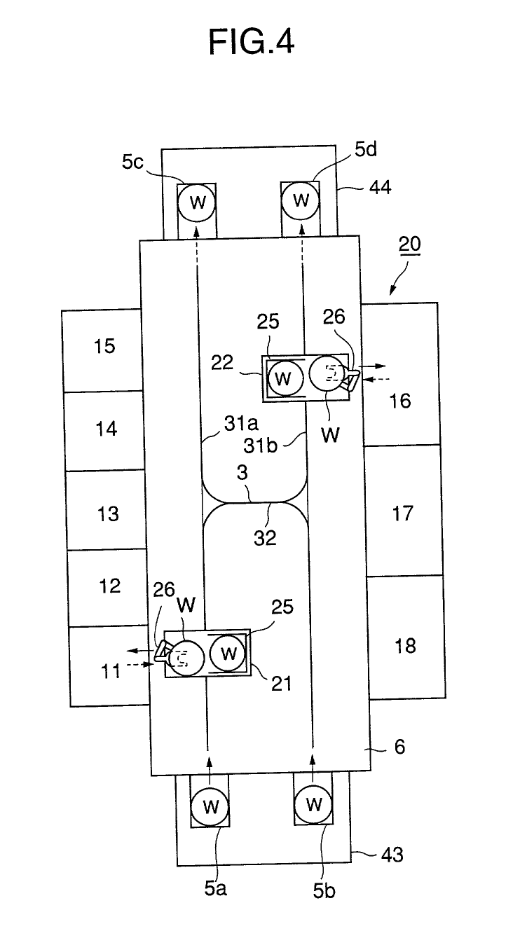

FIG. 4 shows a second example of a processing system according to the present invention. In this processing system 20, same as in FIG. 2, processing parts 11 through 18 are disposed in the periphery. However, a moving path 3 includes two main conveying paths 31a and 31b, and a connecting path 32 connecting them together. Each of two conveying units 21 and 22 is operated by an operation program such that they do not interfere one another. Further, a substrate transfer part 43 for taking out therefrom a substrate which has not been processed yet and a substrate transfer part 44 for loading therein a substrate which has been already processed are disposed on both ends apart. Thereby, transfer of substrates into the conveying units 21 and 22 can be performed efficiently without being interfered by one another. Containers 5a and 5b are disposed in the substrate transfer part 43, while containers 5c and 5d are disposed in the transfer part 44. Respective positions for delivery of substrates between the processing parts 11 through 15 and the containers 5a and 5c are located along the main conveying path 31a, while respective positions for delivery of substrates between the processing parts 16 through 18 and the containers 5b and 5d are located along the main conveying path 31b.

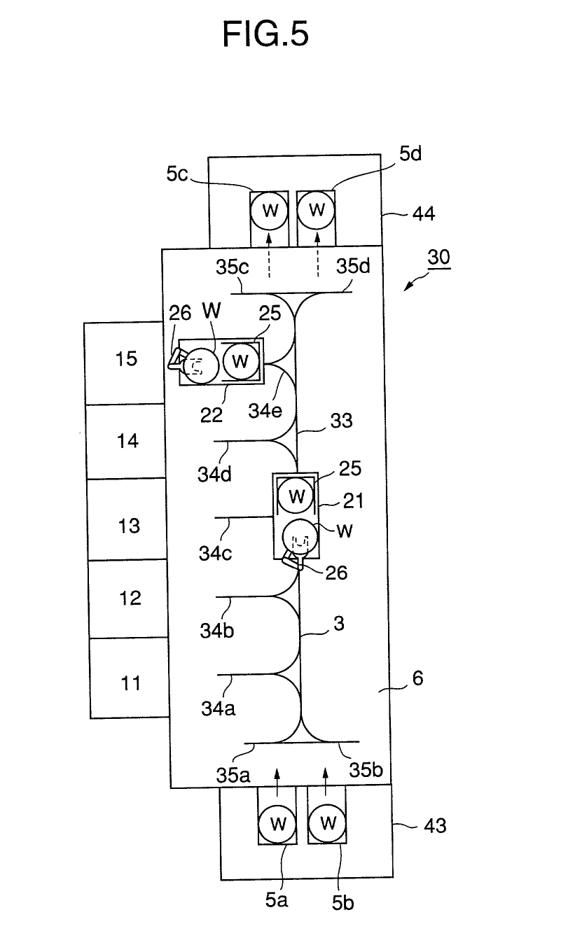

FIG. 5 shows a third example of a processing system according to the present invention. In this processing system 30, processing parts 11 through 14 are disposed only on one side of the system. A moving path 3 includes a main conveying path 33, branch paths 34a through 34e, branching from the main conveying path 33, provided for the respective processing parts 11 through 15, and branch paths 35a through 35d, branching from the main conveying path 33, provided for respective containers 5a through 5d. Each of conveying units 21 and 22 is operated by an operating program such as not to be interfered by one another. The containers 5a and 5b are disposed in a substrate transfer part 43 while the containers 5c and 5d are disposed on a substrate transfer part 44.

Respective positions for delivery of substrates with the processing parts 11 through 15 are located along the branch paths 34a through 34e, respectively, while respective positions for delivery of substrates with the containers 5a through 5d are located along the branch paths 35a through 35d, respectively.

In the processing system 30 shown in FIG. 5, same as in FIG. 2, even when one conveying unit stops at any position, another conveying unit can convey, transfer a substrate W for any processing part or container other than a processing part or a container for which the above-mentioned one conveying unit performs delivery of a substrate, without being disturbed by the one conveying unit.

Further, by the moving path 3 shown in FIG. 5, the processing system 30 shown in FIG. 5, even when the number of conveying units is more than 2, can have the same feature.

For example, in FIG. 5, assuming that two conveying units are set in the moving path 3, while first and second conveying units perform delivery of substrates with the processing parts 11 and 15, respectively, a third conveying unit can convey and transfer a substrate to any of the processing parts 12 through 14 and containers 5a through 5d.

Thus, by the moving path 3 shown in FIG. 5, even when the processing system has more than two conveying units, without being disturbed by one conveying unit which performs delivery of a substrate with a container or a processing part, another conveying unit can convey and transfer a substrate to any container or a processing part other than the container or processing part for which the above-mentioned one conveying unit performs delivery of the substrate. Accordingly, it is possible to improve the net working rates of the conveying units, and to improve the conveying capability (the number of substrates which can be conveyed within a unit time interval) of all the plurality of conveying.

Such a feature of the moving path 3 shown in FIG. 5 is advantageous especially in a case where a long time is required for delivery of substrates at a position at which delivery of substrates is performed with a container or a processing part such as a case in which, for example, a plurality of substrates held in the buffer mechanism 25 are transferred to a container or a processing part, one by one, by a conveying unit which stops at a position for delivery of substrates with the container or processing part, or a plurality of substrates are transferred to and placed on the buffer mechanism 25 from the container or processing part.

In the examples shown in FIGS. 4 and 5, the substrate transfer part 43 is a substrate transfer part for taking out of a substrate W which has not been processed yet therefrom while the substrate transfer part 44 is a substrate transfer part for loading of a substrate W which has been already processed therein. However, in the processing systems 20 and 30 shown in FIGS. 4 and 5, it is also possible that each of the substrate transfer parts 43 and 44 is a substrate transfer part for both taking out of a substrate W which has not been processed yet and loading of a substrate W which has been already processed.

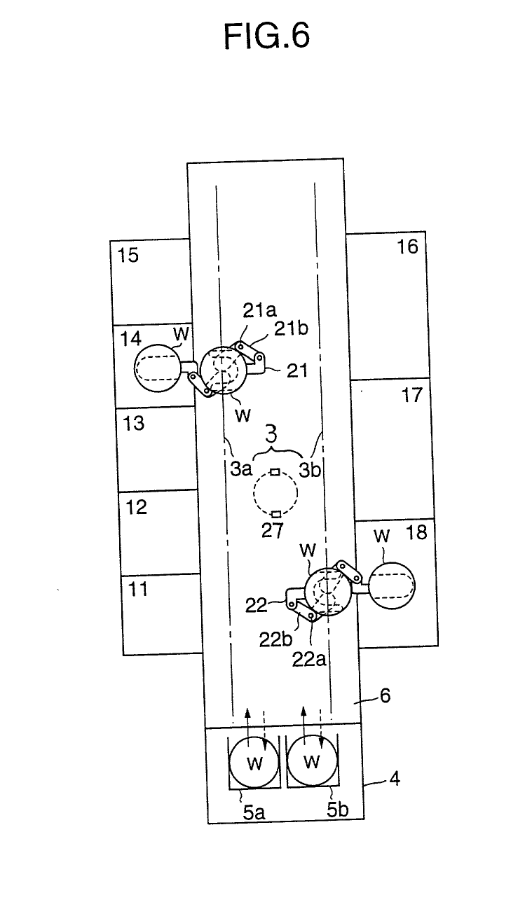

FIG. 6 shows a fourth example of a processing system according to the present invention. In this processing system, same as in the example shown in FIG. 2, processing parts 11 through 15 and 16 through 18 are disposed on both sides of moving paths 3 of conveying units 21 and 22. The moving paths 3 include moving paths 3a and 3b, each of which is like a straight line parallel to one another. The conveying units 21 and 22 movable along the respective moving path 3a and 3b are operated by an operating program such as not to be interfered by one another.

In this example, in comparison to the other examples in which the moving path has a curved part, it is not necessary to regard to a turning radius (a radius of curvature of the curved part of the moving path) for change of direction of the conveying units 21 and 22. Accordingly, it is possible to reduce an area of a conveyance chamber 6. Thereby, it is possible to reduce an area required for setting the entire processing system.

In the example shown in FIG. 6, when it is not necessary to continue processing between processing in any of the processing parts 11 through 15 and processing in any of the processing parts 16 through 18, the conveying unit 21 of the plurality of conveying units 21 and 22 conveys substrates W to the processing parts 11 through 15 while the conveying unit 22 thereof conveys substrates W to the processing parts 16 through 18. However, when it is necessary to continue processing between processing in any of the processing parts 11 through 15 and processing in any of the processing parts 16 through 18, a substrate W may be directly delivered between the plurality of conveying units 21 and 22 by respective transfer units (robot arms), or mutual delivery may be performed through a buffer unit 27 (as, after one transfer unit places a substrate W thereon temporarily, the other transfer unit takes it therefrom). By configuring the buffer unit 27 merely as a simple fixed temporary placement stand, it is not necessary to provide any driving mechanism therein, and, thus, this manner is preferable in a standpoint in that no problem occurs such that a trouble of the driving mechanism disables it from being able to be used. However, it is also possible to configure the buffer unit 27 so that it can move vertically so as to prevent interference with the conveying unit. Further, it is also possible to configure the buffer unit 27 to be like the buffer mechanism 25 shown in FIG. 3, and, thus, it can hold a plurality of substrates in a multi-stage manner. In this case, it is preferable to configure the buffer unit 27 so that the buffer unit 27 can move vertically at a time of delivery of substrates, one by one, with the robot arm.

Further, in the example of FIG. 6, it is also possible to configure the transfer unit of each of the conveying units 21 and 22 so that the transfer unit has a transfer range such as to reach a processing part on the opposite side. Thereby, the transfer unit of the conveying unit 21 can convey substrates to the processing parts 16 through 18 directly while the transfer unit of the conveying unit 22 can convey substrates to the processing parts 11 through 15 directly. This can be achieved by designing the number of joints 21a, 22a, and/or the lengths of arms 21b, 22b, appropriately, when each transfer unit is configured by a multi-joint arm, for example, as shown in the figure. Similarly, by designing the configuration of each transfer unit appropriately, it is possible that each conveying unit 21, 22 can convey substrates W to any of the substrate containers 5a and 5b.

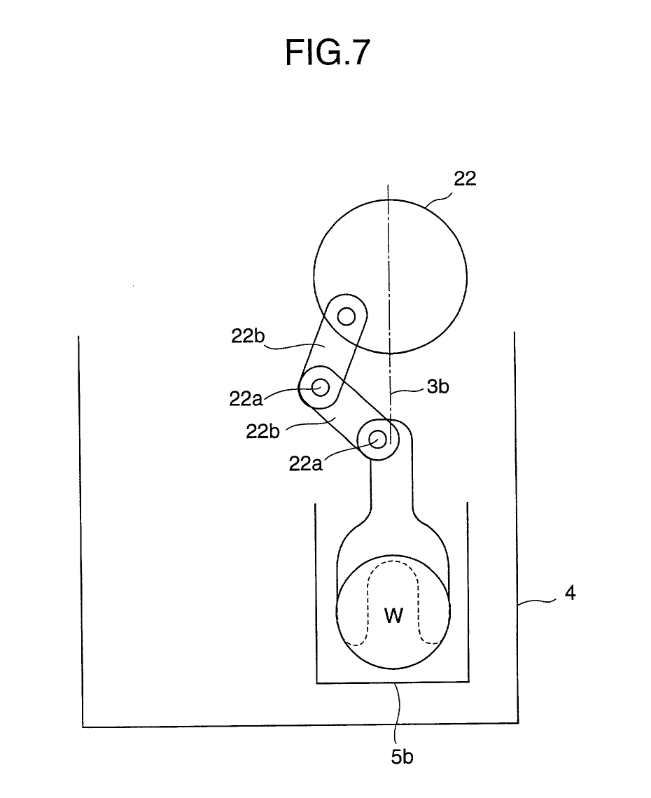

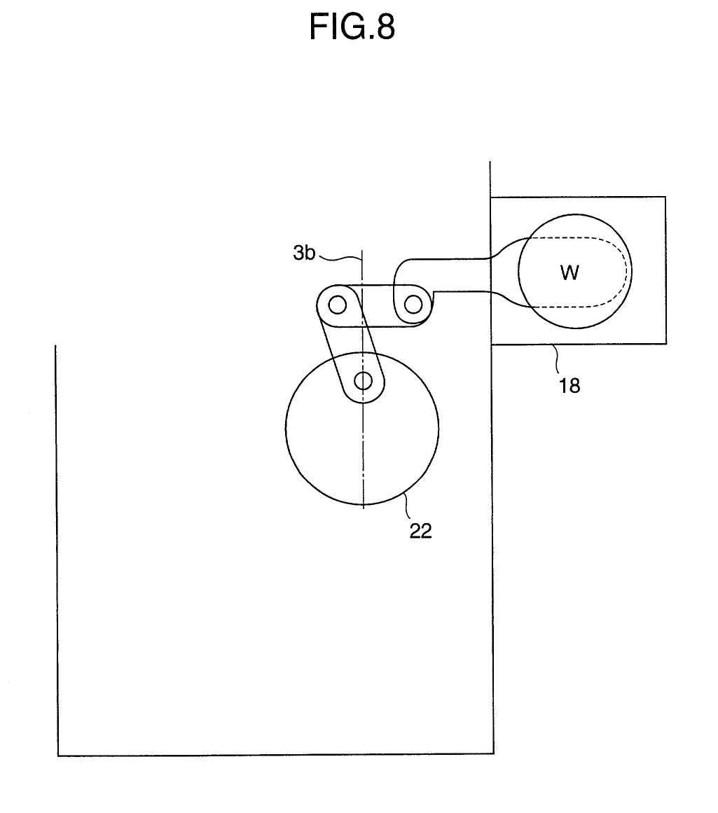

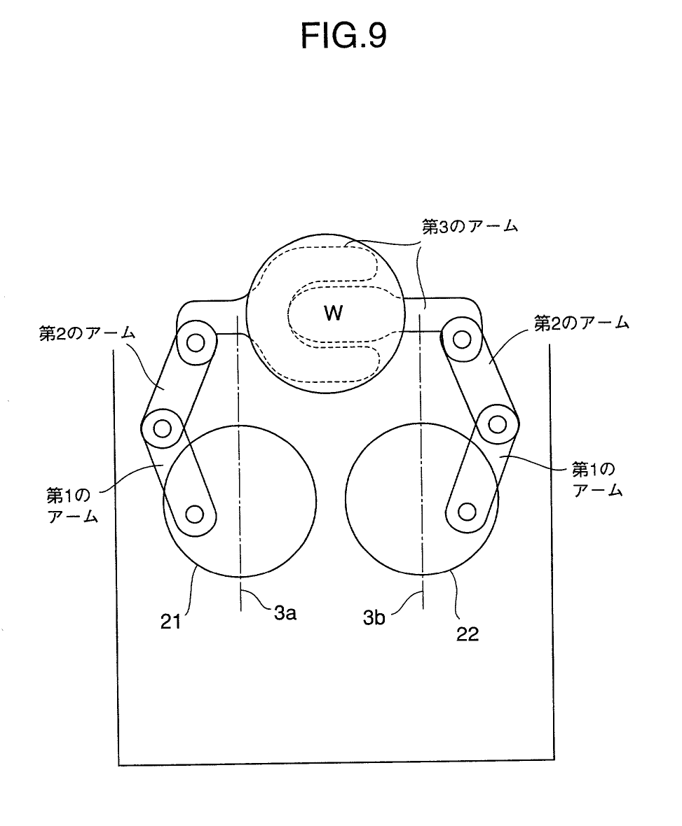

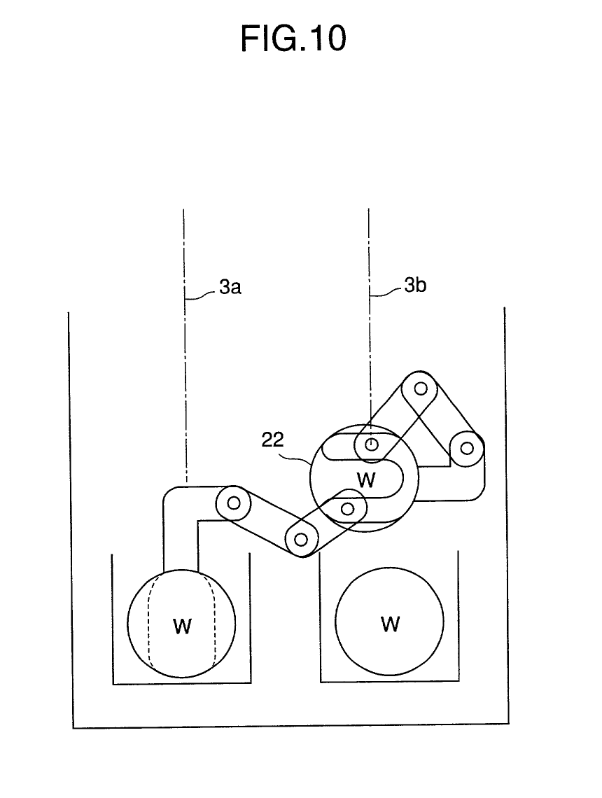

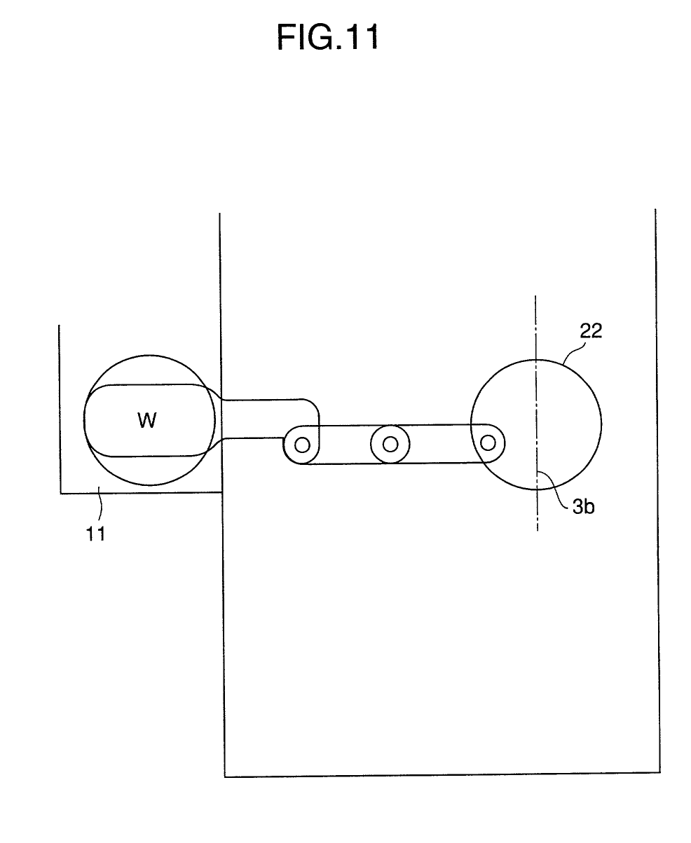

FIGS. 7, 8, 9, 10 and 11 show examples of operation of the transfer unit of the conveying unit 22 in the example of the processing system shown in FIG. 6. As shown in these examples, according to design of the transfer unit, delivery of a substrate between the conveying unit 22 and substrate container 5b (FIG. 7), delivery of a substrate with the substrate container 5a (FIG. 10), delivery of a substrate with the processing part 18 (FIG. 8), delivery of a substrate with the processing part 11 (FIG. 11), and delivery of a substrate between the conveying units 21 and 22 (FIG. 9) are made possible. As shown in FIGS. 9 and 10, the two transfer units (robot arms) which each conveying unit 21, 22 has are different in shape of distal third arms (one is like a spatula while the other is like a fork), and, also, are different in direction of L bends thereof from one another. Also, the two transfer units are reverse in rotation direction of first, second and third arms to one another. By configuring so, the third arms of the conveying units 21 and 22 are prevented from being interfered by one another, when delivery of the substrate W is performed therebetween, as shown in FIG. 9, and, thereby, the delivery can be performed efficiently and smoothly. Further, by configuring the two transfer units of each conveying-unit as being different in shape, operation and function from one another, it is possible to perform delivery of substrates efficiently, by using either transfer unit which is more convenient for respective requirements, when access is made to the respective substrate containers 5a, 5b and processing parts 11 through 18. Further, with regard to each transfer unit (robot arm), by employing a well-known belt-pulley power transmission mechanism, it is possible to operate three joints simultaneously by a single driving source (motor or the like), by providing correspondence relationship between rotation angles of the respective joints (shoulder, elbow and wrist, respectively). However, in a case where it is difficult that operations such as those shown in FIGS. 7 through 11 are performed, due to configuration of surroundings of the respective substrate containers 5a, 5b and processing parts 11 through 18, or the like, when the above-mentioned power transmission mechanism is employed, a driving source may be provided for each one of the respective joints, or some of them.

Further, in the example shown in FIG. 6, it is also possible to provide more than two moving paths. In such a case, the conveying units on the moving paths on both sides are exclusively in charge of delivery of substrates with processing parts on the nearer side, while the conveying unit on the central moving path may be in charge for processing parts on either side. Thus, it is possible to provide flexibility in a conveyance plan, and, thus, to achieve efficient conveyance schedule.

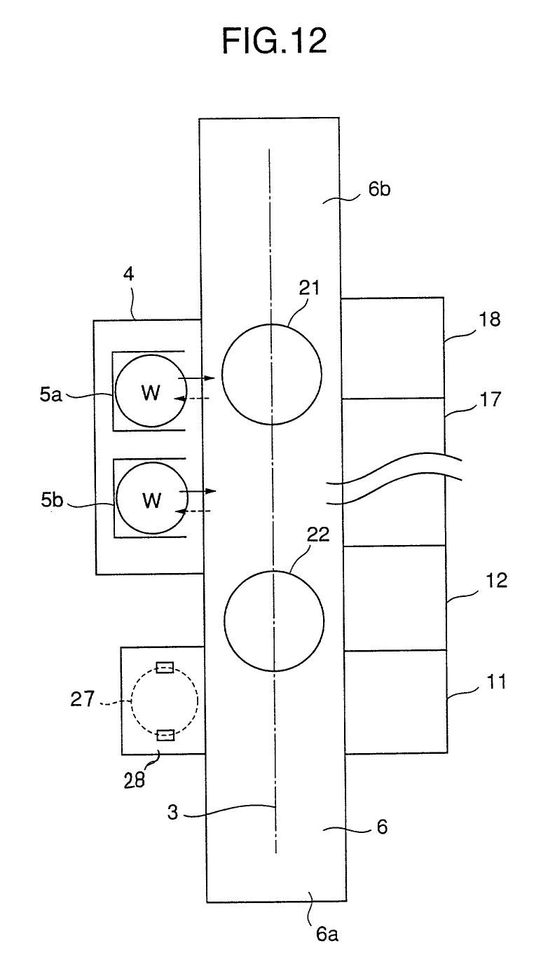

FIG. 12 shows a fifth example of a processing system according to the present invention (however, in the figure, a transfer unit of each conveying unit is omitted from being shown for the sake of simplicity). In this processing system, differently from the example of FIG. 6, only one straight moving path 3 is provided, and, processing parts 11 through 18 are disposed on the right side of the moving path 3 while substrate containers 5a and 5b are disposed on the left side of the moving path 3, in the figure. In this configuration, the area of the conveyance chamber 6 can be reduced further than in the configuration shown in FIG. 6. In this case, in the figure, escape regions 6a and 6b are provided on the top and bottom. For example, as an conveying unit 21 escapes to the escape region 6a, a conveying unit 22 can move through the whole required moving area. Oppositely, as the conveying unit 22 escapes to the escape region 6b, the conveying unit 21 can move through the whole required moving area. Further, in the figure, a buffer room 28 containing a buffer unit 27 is provided on the left side of the moving path 3. The buffer unit 27 can be used as a temporary placement stand when the substrate W is delivered between the conveying units 21 and 22.

Although duplicated description will be omitted, other than the above, also in the examples of FIG. 6 and FIG. 12, such functions/effects as those described above for the examples of the FIGS. 2, 4 and 5 can be produced.

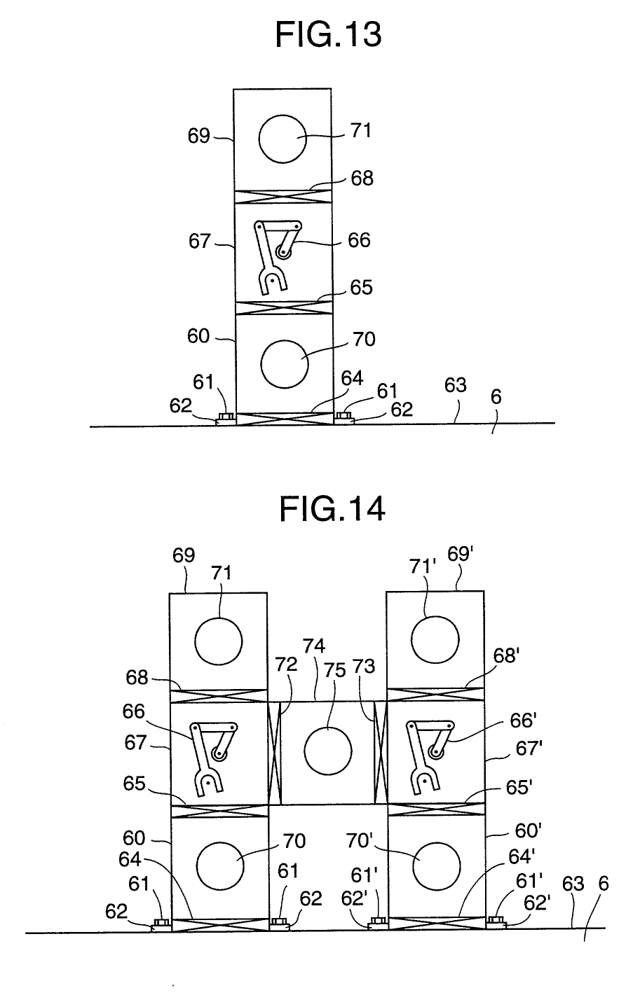

FIG. 13 is a plan view showing one example of a form of the processing part for performing vacuum processing.

This processing part includes a load lock chamber 60 detachably connected with the conveyance chamber 6 through an openable/closeable gate valve 64 as a result of a flange part 62 being fixed onto a side wall 63 of the conveyance chamber 6 by bolts 61, a transfer chamber 67 connected to the load lock chamber 60 through a gate valve 65 and having a transfer unit 66 disposed inside thereof, and a vacuum processing chamber 69 connected to the transfer chamber 67 through a gate valve 68.

By this processing part, the substrate W conveyed to a substrate placement unit 70 inside of the load lock chamber 60 by the conveying unit 21, 22 can be transferred to and placed on a substrate placement unit 71 inside of the vacuum chamber 69 by the transfer unit 66, then the substrate can be made undergo predetermined vacuum processing in the vacuum processing chamber 69, then be transferred from the substrate placement unit 71 inside of the vacuum processing chamber 69 to and placed on the substrate placement unit 70 inside of the load lock chamber 60 by the transfer unit 66, and be conveyed externally from the substrate placement unit 70 inside of the load lock chamber 60 by the conveying unit 21, 22. In this processing part, vacuum processing such as etching processing or CVD processing can be performed on the substrate, for example.

FIG. 14 is a plan view showing another example of a form of the processing part for performing vacuum processing. This processing part includes two load lock chambers 60, 60′ detachably connected to the conveyance chamber 6 through an openable/closeable gate valve 64, 64′ as a result of flange parts 62, 62′ being fixed to a side wall 63 of the conveyance chamber 6 by bolts 61, 61′, two transfer chambers 67, 67′ respectively connected to the load lock chambers 60, 60′ through gate valves 65, 65′ and having transfer units 66, 66′ disposed inside thereof, respectively, two vacuum processing chambers 69, 69′ respectively connected to the transfer chambers 67, 67′ through gate valves 68, 68′, and a relay chamber 74 connected to both the transfer chambers 67, 67′ through gate valves 72, 73.

By this processing part, the substrate conveyed to substrate placement unit 70 inside of the load lock chamber 60 by the conveying unit 21, 22 can be transferred to a substrate processing chamber 71 inside of the vacuum processing chamber 69 by the transfer unit 66, predetermined vacuum processing can be then performed on the substrate in the vacuum processing chamber 69, the substrate can then be transferred by the transfer unit 66 from the substrate placement unit 71 inside of the vacuum processing chamber 69 to and placed on a substrate placement unit 75 of the relay chamber 74, the substrate can be transferred by the transfer unit 66′ from the substrate placement unit 75 of the relay chamber 74 to the vacuum processing chamber 69′, then predetermined vacuum processing can then be performed on the substrate in the vacuum processing chamber 69′, then, the substrate can be transferred by the transfer unit 66′ from the vacuum processing chamber 69′ to and placed on a substrate placement unit 70′ inside of the load lock chamber 60′, and then the substrate in the load lock chamber 60′ can be conveyed externally by the conveying unit 21, 22. In this processing part, consecutive processing such as processing of forming a tantalum oxide film on the substrate and processing of annealing of the Tantalum oxide film, or the like on the substrate.

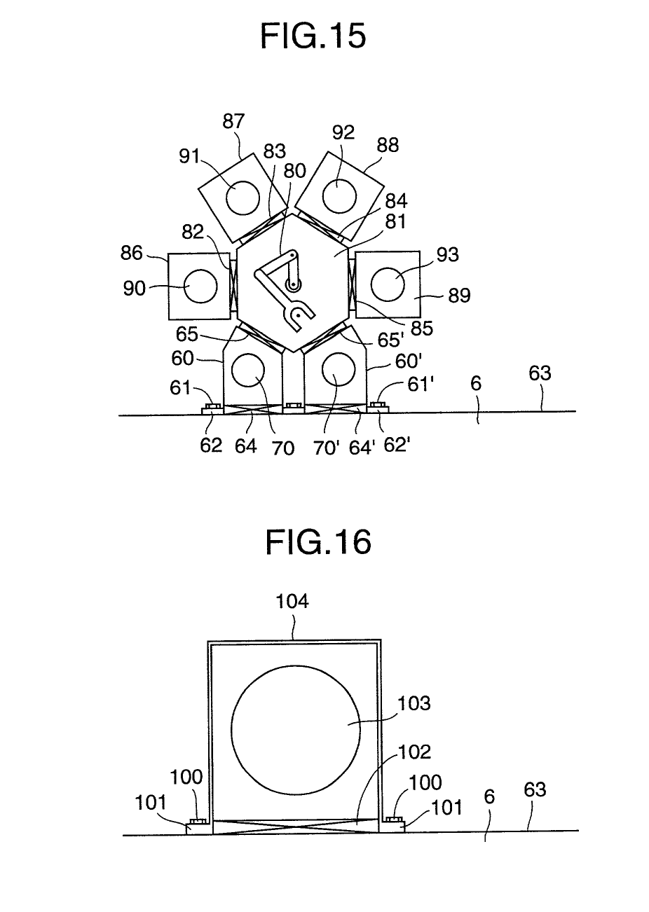

FIG. 15 is a plan view showing another example of a form of the processing part for performing vacuum processing. This processing part includes two load lock chambers 60, 60′ detachably connected to the conveyance chamber 6 through openable/closeable gate valves 64, 64′ as a result of flange parts 62, 62′ being detachably fixed to a side wall 63 of the conveyance chamber 6 by bolts 61, 61′, a common transfer chamber 81 connected to both the load lock chambers 60, 60′ through gate valves 65, 65′ and having a transfer unit 80 disposed inside thereof, four vacuum processing chambers 86 through 89 respectively connected to the transfer chamber 81 through gate valves 82 through 85.

By this processing part, the substrate conveyed into a substrate placement unit 70, 70′ of either load lock chamber 60, 60′ by the conveying unit can be transferred to and placed on a substrate placement unit 90 through 93 inside the vacuum processing chamber '86 through 89, predetermined vacuum processing can be then performed on the substrate in the vacuum processing chamber 86 through 89, the substrate can be transferred by the transfer unit 80 from the substrate placement unit 90 through 93 inside of the vacuum processing chamber 86 through 89 to and placed on the substrate placement unit 70, 70′ inside of either load lock chamber 60, 60′, and the substrate on the substrate transfer unit 70, 70′ inside of the load lock chamber 60, 60′ can be conveyed externally by the conveying unit.

In this processing part, in a case where the four vacuum processing chambers 86 through 89 are made to be vacuum processing chambers different from each other such as to perform consecutive processing, consecutive processing can be performed on the substrate. For example, the four vacuum processing chambers 86 through 89 are made to be processing chambers for performing plasma etching of oxide film, spatter film disposition, CVD, plasma etching of tungsten, respectively, respective substrates are conveyed into the four vacuum processing chambers 86 through 89 in sequence, and the processing are performed in the respective processing parts. Thereby, it is possible to perform consecutive processing on the substrates such as formation of through holes by plasma etching of inter-layer insulating layer→formation of titanium layer acting as an ohmic contact layer for the through holes, and formation of titanium nitride layer acting as a barrier layer on the ohmic contract layer, through spatter film deposition→formation of tungsten layer on the barrier layer through CVD→etch back of the tungsten layer through plasma etching of the tungsten layer, or the like.

Further, in a case where, in this processing part, the four vacuum processing chambers 86 through 89 are made to be vacuum processing chambers for performing a same type of processing, it is possible to perform the same type of processing on the plurality of substrates in parallel.

FIG. 16 is a plan view showing an example of a form of the processing part for performing processing under atmospheric pressure. This processing part includes a processing chamber 104 detachably connected to the conveyance chamber 6 through an openable/closeable shutter 102 as a result of a flange part 101 being detachably fixed to the side wall 63 of the conveyance chamber 6 by bolts 100 and having a substrate placement unit 103 inside thereof.

By this processing part, it is possible to perform predetermined processing on the substrate conveyed to the substrate placement unit 103 inside of the processing chamber 104 by the conveying unit. By this processing part, it is possible to perform processing such as resist coating processing, wet cleaning processing or the like on the substrate.

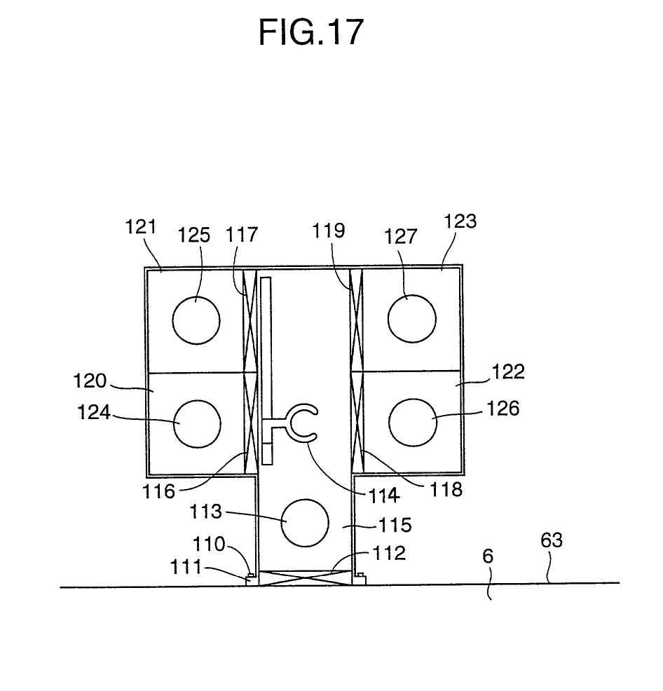

FIG. 17 shows another example of a form of the processing part for processing under atmospheric pressure. This processing part includes a transfer chamber 115 detachably connected to the conveyance chamber 6 through an openable/closeable shutter 112 as a result of a flange part 111 being detachably fixed to the side wall 63 of the conveyance chamber 6 by bolts 110 and having a substrate placement unit 113 and a transfer unit 114 inside thereof, and four processing chambers 120 through 123 connected to the transfer chamber 115 through openable/closeable shutters 116 through 119.

By this processing part, it is possible to transfer the substrates conveyed to the substrate placement unit 113 inside of the transfer chamber 115 by the conveying unit to and place them on substrate placement units 124 through 127 inside of the processing chambers 120 through 123 by the transfer unit 114, and perform predetermined processing on the substrates in the processing chambers 120 through 124.

In this processing part, in a case where the four processing chambers 120 through 123 are made as processing chambers different from each other such as to perform consecutive processing, consecutive processing can be performed on the substrates. For example, the four processing chambers 120 through 123 are made as processing chambers for performing resist coating processing, baking processing after the coating, development processing and baking processing after the development, the respective substrates are conveyed into the processing chambers 120 through 123 in sequence, and the processing are performed in the respective processing parts. Thereby, it is possible to perform consecutive processing on the substrates such as resist coating processing→baking processing after the coating→development processing (on the substrate exposed by an exposure device, not shown in the figure, connected to the processing part)→baking processing after the development, or the like.

Further, in a case where, in this processing part, the four processing chambers 120 through 123 are made as vacuum processing chambers for performing a same type of processing, it is possible to perform the same type of processing on the plurality of substrates in parallel.

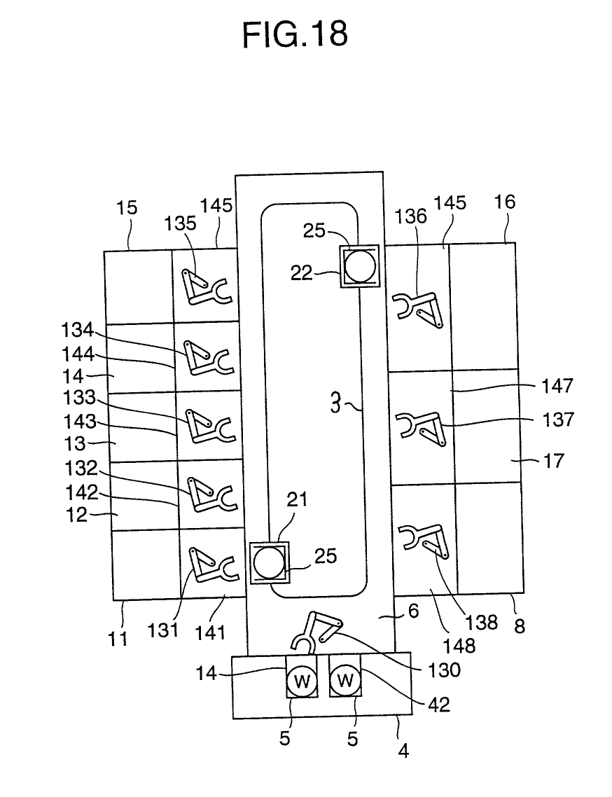

FIG. 18 shows another example in embodiment of the processing system.

Differently from the processing system shown in FIG. 2, a conveying unit has no robot arm for delivery of substrates with containers and processing parts.

In this processing system, the processing parts 11 through 18 may be those in which transfer chambers 141 through 148 provided with transfer units 131 through 138 inside thereof are connected with structures of processing parts shown in FIGS. 15 through 17 (on the side connected to the conveyance chamber 6), for example, and, the transfer units 131 through 138 may perform delivery of the substrates between the conveying units 21, 22 and transfer chambers 141 through 148 (between the conveying units and processing parts). In this case, a transfer unit 130 is used for delivery of the substrates W between a containers 5 of a substrate transfer part 4 and the buffer mechanism of the conveying unit 21, 22.

Other than the above, also in the examples shown in FIGS. 4, 5, 6 and 12, it is possible that the transfer units are not provided in the conveying units but provided on the end of the processing parts and substrate containing parts.

In the above-described processing systems, as the plurality of processing parts are provided, various processing can be performed.

For example, in the processing system shown in FIG. 2, in a case where the processing parts 11 through 18 are made as etching processing parts, parallel processing is performed by using the eight etching processing parts, and, thereby, the etching processing on the plurality of substrates can be performed within a short time interval.

Further, for example, in the processing system shown in FIG. 2, in a case where the processing parts 11 through 13 are made as etching processing parts, the processing parts 14 and 15 are made as ashing processing parts, and the processing parts 16 through 18 are made as cleaning processing parts, the substrates are conveyed in sequence in that any of the processing parts 11 through 13→any of the processing parts 14 and 15→any of the processing parts 16 through 18. Then, processing is performed in the respective processing parts. Thereby, it is possible to perform consecutive processing of etching→ashing→cleaning on the substrates within a short time interval.

Further, for example, in the processing system shown in FIG. 2, inspection devices may be set and arranged to a row of the processing parts 11 through 15 and/or to a row of the processing parts 16 through 18, and the substrates may be conveyed to the inspection devices by the conveying units 21 and 22. Then, after and/or before processing in the processing parts, predetermined inspection such as tests for electrical properties, and so forth, may be performed on the substrates.

Further, in the processing systems shown in FIGS. 2, 4, 5, 6, 12 and 18, both the conveying units 21 and 22 may be used for conveyance from the container 5 disposed in the substrate transfer part 41 to the respective processing parts. Thereby, it is possible to complete processing on all the substrates held in the single container 5 disposed in the substrate transfer part 41 within a short time interval.

Furthermore, in the processing systems shown in FIGS. 2, 4, 5, 6, 12 and 18, as all the conveying units 21 and 22 can move along the moving path 3, it is possible to easily add new processing parts, by extending the moving range of the conveying units 21 and 22 by extending the moving path 3.

As the processing parts are made to be connected to the conveyance chamber 6 detachably by the bolts as in the processing parts shown in FIGS. 13 through 17, it is possible to replace of the processing parts and/or add new processing parts easily.

The present invention is not limited to the above-described embodiments, and variations may be made without departing from the scope of the present invention.

The entire contents of Japanese Patent Application No. 2000-103402 which is a basic application of the present application are hereby incorporated by reference.

1. A processing system comprising:
a transfer part in which a container is disposed for performing taking out therefrom an object which has not been processed yet and loading therein the object which has been already processed;
a processing part for performing predetermined processing on the object; and
a plurality of conveying units conveying the object between a first position for delivery of the object with the container disposed in the transfer part and a second position for delivery of the object with the processing part, wherein:
each of said plurality of conveying units can move between said first position and second position;
a moving path of the conveying units comprises a plurality of paths respectively along an arrangement of the processing parts; and
each of the conveying units can solely perform delivery of the object with the processing part on both sides of the moving path or the transfer part.

2. A processing system comprising:
a transfer part in which a container is disposed for performing taking out therefrom of an object which has not been processed yet and loading therein the object which has been already processed;
a processing part for performing predetermined processing on the object; and
a plurality of conveying units conveying the object between a first position for delivery of the object with the container disposed in the transfer part and a second position for delivery of the object with the processing part, wherein:
each of said plurality of conveying units can move between said first position and second position;
a moving path of the conveying units comprises a plurality of paths respectively along an arrangement of the processing parts; and
by providing a temporary placement stand, delivery of the object can be performed through the temporary placement stand between the plurality of be conveying units.

3. A processing system comprising:
a transfer part in which a container is disposed for performing taking out therefrom of an object which has not been processed yet and loading therein the object which has been already processed;
a processing part for performing predetermined processing on the object; and
a plurality of conveying units conveying the object between a first position for delivery of the object with the container disposed in the transfer part and a second position for delivery of the object with the processing part, wherein:
each of said plurality of conveying units can move between said first position and second position;
a moving path of the conveying units comprises a plurality of paths respectively along an arrangement of the processing parts; and
delivery of the object can be performed directly between the plurality of conveying units.

4. A processing system comprising:
a transfer part in which a container is disposed for performing taking out therefrom of an object which has not been processed yet and loading therein the object which has been already processed;
a processing part for performing predetermined processing on the object; and
a plurality of conveying units conveying the object between a first position for delivery of the object with the container disposed in the transfer part and a second position for delivery of the object with the processing part, wherein:
each of said plurality of conveying units can move between said first position and second position;
a moving path of the conveying units comprises only a single path; and
said single path has both ends thereof as being dead ends, respectively.

5. A processing system comprising:
a transfer part in which a container is disposed for performing taking out therefrom of an object which has not been processed yet and loading therein the object which has been already processed;
a processing part for performing predetermined processing on the object; and
a plurality of conveying units conveying the object between a first position for delivery of the object with the container disposed in the transfer part and a second position for delivery of the object with the processing part, wherein:
each of said plurality of conveying units can move between said first position and second position; and
a main conveying path, and, a plurality of branch paths each provided for each processing part, branching from said main conveying path and reaching the second position corresponding to each of the plurality of processing parts, are provided.

6. A processing system comprising:
a transfer part in which a container is disposed for performing taking out therefrom of an object which has not been processed yet and loading therein the object which has been already processed;
a processing part for performing predetermined processing on the object; and
a plurality of conveying units conveying the object between a first position for delivery of the object with the container disposed in the transfer part and a second position for delivery of the object with the processing part, wherein:
each of said plurality of conveying units can move between said first position and second position; and
the transfer part for taking out therefrom the object and the transfer part for loading therein the object are united.

7. The processing system as claimed in any one of claims 1 through 6, wherein:
the object comprises a semiconductor substrate; and
the processing performed by the processing part comprises processing relating to semiconductor manufacturing.

8. The processing system as claimed in any one of claims 1 through 6, wherein:
each conveying unit has a plurality of transfer units; and
the respective transfer units are different in shape, operation and function thereof from each other.

9. The processing system as claimed in any one of claims 1 through 6, wherein the conveying unit has a transfer unit, and the transfer unit comprises a plurality of arm parts and joint part connecting them.

10. The processing system as claimed in any one of claims 1 through 6, wherein the respective processing part and transfer part have transfer units, and the object is delivered between the respective processing part and transfer part, and the conveying units by the transfer units.

11. The processing system as claimed in any one of claims 1 through 3, wherein the plurality of paths are approximately parallel to each other and each is like a straight line each, and also, they have both ends as being dead ends.

12. The processing system as claimed in claim 4, wherein said single path is like a straight line.

13. The processing system as claimed in claim 4, wherein an escape region is provided in a processing chamber.
